(19) United States
(12) Patent Application Publication
(10) Pub. No.: US 2008/0133280 A1
(43) Pub. Date: Jun. 5, 2008

(54) ASSET POOL WITHDRAWAL GUARANTEE

(76) Inventor: RONALD L. ZIEGLER, SWISHER, IA (US)

Correspondence Address: SHUTTLEWORTH & INGERSOLL, P.L.C., 115 3RD STREET SE, SUITE 500, P.O. BOX 2107, CEDAR RAPIDS, IA, 52406, US

(21) Appl. No.: 11/951,066

(22) Filed: Dec. 5, 2007

Related U.S. Application Data
(60) Provisional application No. 60/868,664, filed on Dec. 5, 2006.

(51) Int. Cl. G06Q 40/00

(52) U.S. Cl. 705/4

(57) ABSTRACT

A method for administering a withdrawal guarantee that insures against the loss an individual would incur in the event that a pool of assets is depleted due to withdrawals, investment performance, charges, expenses, or a combination thereof.

### RELATED APPLICATIONS

This patent application is based upon U.S. Provisional Application Ser. No. 60/868,664 filed on Dec. 5, 2006, the complete disclosure of which is hereby expressly incorporated by reference.

### BACKGROUND OF THE INVENTION

Changing demographics caused in part by the upcoming retirement of the baby-boomer generation is causing many “pay as you go” retirement programs to become unsustainable. In addition, poor equity market performance early in this decade, stricter minimum funding requirements and proposals for market value accounting are causing many employers to abandon defined benefit pension plans in favor of defined contribution plans. These and other factors result in the transfer of responsibility for retirement security to the individual. However, current financial products do not meet the retirement income needs of many retirees.

When determining how to invest for retirement, a person must consider a number of different factors, including investment risk, inflation, and longevity. Balancing these factors can be difficult. For example, in order to save for retirement in a way that protects against the eroding effects of inflation, exposure to equity or other volatile investments may be beneficial. However, these types of investments carry increased risk because their value may drop suddenly at the time the person retires, thereby depleting retirement funds just when they are needed most. Because of this risk, many investment advisors recommend shifting to fixed income investments as one nears retirement since their values are more stable. However, fixed income investments are also not without risk as their value may be diminished over time due to inflation.

Currently, the most common method of providing income during retirement, other than from Social Security and pensions, is to take withdrawals on a regular basis from accumulated assets. These assets may be invested in mutual funds, 401(k) accounts, Individual Retirement Accounts (IRAs), etc. One of the risks associated with this regular withdrawal method is that the retiree will outlive their assets.

Some current retirement income planning tools attempt to quantify the risks of asset value fluctuation, longevity, and inflation by using Monte Carlo simulations to calculate the probability of “success.” Monte Carlo simulations are known generally in the investment and insurance industries. In these simulations, success is defined as the retiree's assets providing withdrawals lasting their lifetime, based on a chosen investment allocation and various economic and life expectancy assumptions. One major flaw in the analysis of many of these planning tools is the assumption that the planning horizon is equal to the remaining life expectancy of the retiree. Half of the retirees are expected to outlive this planning horizon because life expectancy is defined as the point at which half of a group of people today is still expected to be alive in the future. So the definition of “success” under these simulations is flawed for 50% of the people.

Another flaw, even if this first one is corrected, is that anything but 100% probability of success leaves retirees with some chance of failure. The ramifications of failure can be devastating for those individuals who become dependent on welfare and no longer enjoy the freedoms they previously had.

To reach near-100% probability of success, withdrawal rates must be reduced to such low levels that most retirees could not support themselves on the resulting amount of withdrawals. Alternatively, the asset mix must be adjusted to be very conservative. This reduces the volatility of the asset values, reducing the likelihood that poor investment performance will cause depletion of assets through withdrawals. One of the limitations with these more conservative investments, however, is the eroding effects of inflation on the withdrawals. If the amount of withdrawals is indexed to inflation, poor investment performance could cause the reduction in principal, potentially depleting the assets during the retiree's lifetime.

Insurance companies have created products to help address the needs of retirees by overcoming some of the limitations discussed above. One of the oldest products is the immediate annuity, also known as the payout annuity. This product does an excellent job of relieving the retiree of longevity risk, that is, the risk that they will outlive the income their assets provide. Most payout annuities, however, have drawbacks that make them less appealing to retirees than merely withdrawing funds from a pool of assets. Fixed payout annuities typically pay a fixed dollar amount each month for the life of the retiree. This leaves the retiree bearing all of the risk that inflation will reduce their real dollar income in the future. Variable payout annuities help address this by offering payments that directly increase based on the favorable investment performance of a pool of assets which the insurance company has made available within the variable annuity. Some of these assets are typically stock portfolios whose investment performance over time could be expected to help offset the impact of inflation. One limitation with variable payout annuities is the variability of monthly income payments, since they are directly affected by the investment performance of the asset portfolios chosen. Guarantees that payments will be at least as high as some minimum amount are offered by some insurance companies for a fee. This helps address the variability of income, but usually only guarantees the income will not fall below the amount of the initial payment. Many years in the future, this guarantee is similar to a fixed payout annuity guarantee in that inflation may have reduced the real dollar value of these payments.

Another limitation with payout annuities is the perception by retirees and their advisors that the insurance company keeps their money upon an early death. In reality, the insurance company is pooling insured lives and providing payments to those who live a long life by charging a premium to all insured annuitants that reflects the probability of living to future dates. The premiums expected to be “forfeited” by those dying early help provide payments to those living longer. Even though this risk pooling is a primary underpinning of insurance, it is a factor that makes many retirees perceive lifetime payout annuities as being undesirable.

Another limitation with payout annuities is that most do not provide significant flexibility in the payments they provide. One cannot typically start, stop or skip payments, or modify the amount of payments. In addition, payout annuities are sometimes difficult for the typical retiree to understand since payout annuities represent a stream of payments, and historically have not carried an “account value.”

Because of the drawbacks of payout annuities, insurance companies have created other retirement income solutions, specifically new types of guarantees that are attached to deferred annuities. A deferred annuity is an insurance product that allows a policyholder to make premium payments (deposits) which accumulate with interest (in the case of a fixed annuity) or participate in the investment performance of chosen mutual fund sub-accounts (in the case of a variable annuity). This accumulated account value can be converted into a payout annuity to provide a retirement income. Alternatively, the policyholder typically has the right to take systematic withdrawals from the deferred annuity which provides a regular cash flow instead of annuitizing for a payout annuity.

Insurance companies are now providing guaranteed withdrawal programs on deferred annuities. One such guarantee is commonly referred to as the Guaranteed Minimum Withdrawal Benefit (GMWB). The purpose of the GMWB is to provide a guarantee that the annuity owner will receive back a minimum amount of money through regular withdrawals. The most popular GMWB gives a policyholder the right to withdraw up to a specified percentage of an initial deposit every year until the entire principal is returned. In a poor equity market, it is possible for the variable annuity account balance to be depleted through these withdrawals prior to the policyholder having received their original deposit back. In the event the account balance is depleted, the insurance company provides distributions to the policyholder for the rest of the period needed in order for the policyholder to receive their original deposit back.

An example of a common GMWB is as follows: A person deposits $100,000 in an annuity contract with a GMWB feature. With a seven percent withdrawal allowance, the policyholder could withdraw up to $7,000 each year until the total amount withdrawn reaches $100,000. This would take slightly longer than 14 years if the policyholder withdrew $7,000 in each consecutive year. The policyholder may withdraw the funds irrespective of the investment performance of the chosen sub-accounts. The policyholder's income stream is protected, regardless of market performance. If the market performs poorly, the account value may be depleted through these withdrawals. In this example, poor investment performance could cause the withdrawals to deplete the account value after, for example, 10 years. In this case, the insurance company would pay the policyholder $7,000 in each of years eleven through fourteen plus a final payment of $2,000 in the fifteenth year. This fulfills the insurance company's obligation under the GMWB to ensure that the policyholder receives the return of his entire $100,000 principal through annual withdrawals of $7,000 or less. At that point, the annuity contract would be terminated and no further payments would be made to the policyholder.

On the other hand if the market does well, the GMWB policyholder participates in this growth. If, for example, the investment account grows at a compound annual rate of ten percent the policyholder would have an account value of $183,925 after fourteen years and still have had the benefit of the withdrawal amount of $7,000 for fourteen years. So, with this form of GMWB there is the potential for increased income in the future.

While the GMWB provides a valuable guarantee of return of principal, it does not meet the needs of most retirees because it does not provide protection against longevity risk. Another kind of withdrawal guarantee is now available which addresses that risk. It is a Guaranteed Lifetime Withdrawal Benefit (GLWB), also known as a GMWB for life. The GLWB guarantees that policyholders can take withdrawals from the deferred annuity for as long as they live, even if their account value is depleted due to withdrawals, investment performance, charges, expenses, or a combination thereof.

An example of a common GLWB is as follows: A person deposits $100,000 in an annuity contract with a GLWB feature. With a five percent withdrawal allowance, the policyholder could withdraw $5,000 each year for the rest of her lifetime. The policyholder may withdraw the funds irrespective of the investment performance of the chosen sub-accounts. The policyholder's income stream is protected, regardless of market performance. If the market performs poorly, the account value may be depleted through these withdrawals. In this example, poor investment performance could cause the withdrawals to deplete the account value after, for example, 10 years. In such a case, the insurance company would pay the policyholder $5,000 in each year until the policyholder dies. This fulfills the insurance company's obligation under the GLWB to ensure that the policyholder receives her guaranteed annual withdrawal amount of $5,000 for as long as she lives. At that point, the annuity contract would be terminated and no further payments would be made (unless there was also a guaranteed death benefit to the policyholder's beneficiaries).

This GLWB is an attractive annuity option to those who need a retirement income and want to maintain control of their assets instead of converting their deferred annuity to a payout annuity, which usually offers less flexibility. The GLWB option in deferred annuities allows the policyholder the ability to start, stop and skip withdrawals and/or change withdrawal amounts up to a predetermined maximum amount. This is contrasted with the less flexible payout annuity that requires pre-defined, scheduled annuity income benefit payments for which the policyholder typically cannot change the amount or frequency.

While the GLWB has increased in popularity in recent years, the vast majority of the population's retirement assets reside in investments other than deferred annuity contracts which can provide these guarantees. Most retirement assets are held in mutual funds, 401(k) accounts and Individual Retirement Accounts (IRAs). Mutual funds do not have the authority under current law to provide a GLWB as part of the mutual fund. Retirement accounts such as 401(k) and IRA accounts can offer these guarantees if the funding vehicle for the assets is an annuity. Most of those assets are not held in annuities, however, and, therefore, owners of such retirement accounts cannot receive these guarantees.

Even when the assets are held in an annuity and the insurance company offers a GLWB, the policyholder has certain limitations which may not be desirable. For example, the annuity policy may have a limited number of mutual fund sub-accounts available to the policyholder. Or, the policyholder may wish to invest in mutual funds not offered by the insurance company. If the policyholder were to withdraw funds from the annuity to make such investment, the holder would forfeit the GLWB benefit attached on these funds. To gain access to a different fund manager, the policyholder may incur sales charges to switch annuities. In other cases, the policyholder may be satisfied with his annuity, but that annuity may not offer a GLWB. Again, the holder must switch out of an annuity he owns in order to gain the lifetime withdrawal guarantees he desires.

Another limitation with annuities having GLWBs is that since the guarantee only applies to the assets that are within the annuity, the policyholder's tax planning options are limited. For example, the policyholder may have two annuities, one funding a traditional IRA and one funding a Roth IRA. Each of these annuities may have a GLWB. However, if a policyholder wishes to take more out of the Roth IRA in a given year to reduce her taxable income in that year, she would be limited in her ability to accomplish that without negatively affecting future value of the GLWB, i.e. excess withdrawals reduce future guaranteed benefits.

For example, assume a person deposits $100,000 in an annuity contract with a 5% GLWB funding a traditional IRA and another $100,000 in an annuity contract with a 5% GLWB funding a Roth IRA. In each year, the policyholder can withdraw up to $5,000 from each annuity without negatively affecting the policy holder's future GLWB. The $5,000 withdrawal from the traditional IRA would be included as taxable income whereas the $5,000 withdrawal from the Roth IRA would be tax-free. If the policyholder's marginal tax rate is 15%, taxes on the $5,000 withdrawal from the traditional IRA would be $750. The total after-tax income from these withdrawals would be $5,000−$750=$4,250 from the traditional IRA plus $5,000 from the Roth IRA for a total of $9,250. If the policyholder has extra income one year, say from working a part-time job, he could be pushed into a higher tax bracket on the traditional IRA withdrawal. For example, the traditional IRA withdrawal might be subject to a 25% tax rate, resulting in $1,250 in taxes instead of $750. In this case, the policyholder may wish to take $10,000 from his Roth IRA that year and not have any income taxed at the 25% tax rate. If he does this, the GLWB on the Roth IRA will treat the additional $5,000 withdrawal as an excess withdrawal. This would reduce, or even eliminate, the GLWB amount going forward on the Roth IRA.

Thus, since current GLWB's are only covering assets within a single annuity contract and since various kinds of tax qualified and non-tax qualified dollars can not be co-mingled in a single annuity, current products do not allow for more holistic retirement income planning while still providing full lifetime income guarantees.

Some insurance companies are now offering a “longevity insurance” product which helps overcome some of the shortfalls of both variable annuities with GLWB benefits and mutual funds. The typical longevity insurance product is structured as a lifetime payout annuity where the first payment is made many years in the future. The policyholder pays a single premium to purchase this payout annuity. For example, for a $10,000 single premium paid at age 65, the policyholder will receive annuity payments of $8,000 per year at age 85 for the rest of the policyholder's life. Typically, this product is irrevocable. After the single premium is paid, the holder has no access to the money. It is pure insurance. If the insurable event does not occur, it does not pay benefits. The insurable event in this case is survival to age 85. If the policyholder dies before this time, no benefits are received from the annuity. An alternate version of longevity insurance provides a death benefit prior to the income starting date. However, the amount of income it provides for the same single premium amount is significantly less than the pure longevity insurance design.

The longevity insurance annuity is intended to complement other retirement instruments. As mentioned above, some financial planning tools use Monte Carlo simulations to calculate the amount that can be withdrawn from a pool of assets in order to have a certain probability of “success.” Success is defined as maintaining the assets to provide an income for a given period of time. By combining a mutual fund with an annuity that provides longevity insurance, the planning time horizon for the Monte Carlo simulation is known. In the example immediately above, the planning horizon would be 20 years, from age 65 to age 85. The mutual fund withdrawals can be set at an amount which have a certain probability of lasting 20 years. At that point in time, income from the longevity insurance annuity would begin so that income from the values held in the mutual funds would no longer be needed.

One of the limitations with longevity insurance is the loss of control the policyholder experiences after paying the single premium deposit. This is a pure insurance premium and access to this money is forfeited if the insurable event does not occur. Many retirees find such an irrevocable decision unappealing. In addition, since the longevity insurance has only one contingency, survival to the payout date, the contract must provide payments to everyone who survives the deferral period. Depending on investment performance, many people do not need the income from the longevity insurance annuity at the scheduled payout date because their mutual fund still has value at that point in time.

There is another limitation which is more troublesome than not needing the income after the deferral period because the mutual fund was not depleted. That is the situation where the mutual fund is depleted prior to the income starting from the longevity insurance annuity. For example, withdrawals from the mutual fund could be set at a level to have an 80% probability of success. In 80% of the economic scenarios, the income from the longevity insurance is not needed when it begins to be paid because the mutual fund still has value in it which can continue to provide withdrawals for income. So in these cases, surviving retirees have essentially purchased more insurance than they need. On the other hand, in 20% of the economic scenarios, the mutual fund will be depleted prior to the income from the longevity insurance commencing. In this case, surviving retirees do not have “enough” insurance, i.e., they needed insurance to provide income sooner than their inflexible longevity insurance annuity provided.

Therefore, there is a need for a new type of financial instrument which protects against investment risk and longevity risk in a coordinated fashion, but which provides retirees with the flexibility to change their retirement assets as needed.

### SUMMARY OF THE INVENTION

The invention provides a withdrawal guarantee on a pool of assets such as a mutual fund account, a 401(k) account, an Individual Retirement Account (IRA), a brokerage account, a separately managed account, or any other type of account or pool of assets. The assets do not necessarily need to be held or controlled by the entity providing the insurance. The invention insures against the loss an individual would incur in the event that the pool of covered assets is depleted due to withdrawals, investment performance, charges, expenses, or a combination thereof. The insurable event (i.e., the depletion of a pool of covered assets) results in potential insurance guarantee payments to the owner of the account by the insurance company. In some embodiments, the loss indemnified is the amount of money the owner was entitled to receive prior to the depletion of the covered asset pool. This indemnification will continue for a predetermined period of time according to the contractual guarantee, which could be for the insured's lifetime.

The account owner is entitled to take withdrawals from the pool of covered assets, however, withdrawals from the covered assets are restricted in some fashion. An example would be implementation of a cap on total withdrawals for a predetermined period of time. The withdrawal restrictions may apply to a single predetermined period of time (typically yearly) or may relate to multiple periods of time, e.g. designating the maximum withdrawal amount for a rolling three year period. The maximum withdrawal amount may be level each year or it may vary according to some formula such as a fixed percentage increase each year or it may be tied to some index, such as the Consumer Price Index. The maximum withdrawal amount could be higher in the early years after retirement to “bridge” income from working years to the time when Social Security or pension plan payments commence.

The form of the withdrawal guarantee is a contingent payout annuity. In general terms, a contingent payout annuity is an annuity that provides income payments upon the occurrence of some contingency. In various embodiments there are a variety of contingencies that determine whether insurance guarantee payments are made from the insurance company to the account owner. In some embodiments, the amount of such payments may also be contingent on one or more events. One contingency is the depletion of the assets in the asset pool, which may be caused by withdrawals, investment performance, charges, expenses, or a combination thereof. A second possible contingency is the survival of the owner of the account (or their joint owner). A third possible contingency is a nursing care, critical illness, or disability event. For example, annuity payments may commence or be increased upon a qualified nursing care, critical illness, or disability event. Another possible contingency is death, where a death benefit is provided which ensures that upon the account owner's death, a minimum amount is available for the decedent account owner's heirs.

The amount of the insurance guarantee payments, if any, is determined by reference to the account owner's deposit and withdrawal activity on the pool of covered assets and may be affected by the investment performance of these assets. These insurance guarantee payments, when made, may be level each year or may vary according to a formula such as a fixed percentage increase each year or may be tied to some index, such as the Consumer Price Index. They may be higher in the early years after retirement to “bridge” income from working years to the time when Social Security or pension plan payments commence. They may also be linked to the performance of an asset portfolio or a financial market index such as a commonly known stock index.

### BRIEF DESCRIPTION OF THE DRAWINGS

FIG. 1 is a flow chart showing an embodiment of the present invention;

FIG. 2 is a flow chart showing an embodiment of the workflow of the present invention;

FIG. 3 is an illustration of a main central processing unit for implementing the computer processing in accordance with a computer implemented embodiment of the present invention;

FIG. 4 illustrates a block diagram of the internal hardware of the computer of FIG. 3; and

FIG. 5 is a flow chart of the daily management process of an embodiment of the invention.

### DETAILED DESCRIPTION OF THE INVENTION

The invention provides withdrawal guarantees on a pool of assets such as a mutual fund account, a 401(k) account, an Individual Retirement Account (IRA), a brokerage account, a separately managed account, or any other type of account or pool of assets. The assets do not need to be held or controlled by the same entity providing the guarantee. In one embodiment, the invention insures against the loss an individual (account owner) would incur in the event that their pool of covered assets is depleted due to withdrawals, investment performance, charges, expenses, or a combination thereof. It should be noted that certain embodiments of the invention may apply to situations where an entity or other non-natural person owns a pool of assets as well as situations where an individual or group of individuals owns a pool of assets. Further, it should be noted that the pool of assets may contain other assets which are not covered by the withdrawal guarantee. Still further, it should be noted that the pool of covered assets may contain assets from more than one type of account. Still further, it should be noted that the steps of this method do not necessarily have to be performed in the order they are described below or the order they are listed in the claims.

The account owner can deposit funds into an asset pool that is already covered by the withdrawal guarantee, or the account owner can purchase the withdrawal guarantee to cover an existing pool of assets. In either case, a withdrawal base is determined for the pool of assets to be covered by the insurance. This withdrawal base is typically equal to the amount of funds deposited into the covered asset pool, or the amount of assets in a covered asset pool at the time the withdrawal guarantee is purchased. The withdrawal base can be adjusted up or down from the actual amount of covered assets, i.e., the insurance protection may be more or less than the actual amount of funds deposited into or held in the covered asset pool, but will always be a function of the amount of funds deposited into or held in the covered asset pool. The withdrawal base is increased whenever additional funds are added to the covered asset pool. Removal of assets from the covered asset pool in excess of the maximum withdrawal amount (discussed below) may result in a decrease to the withdrawal base.

In some embodiments, the withdrawal base may increase according to a formula, such as a fixed percentage increase each year or according to the change in an index, such as the Consumer Price Index. Alternatively, it could increase based on the investment performance of the covered asset pool. For example, the withdrawal base could step up to the amount of the covered asset pool periodically if the amount in the asset pool increased above the amount of the withdrawal base due to positive investment performance.

An insurance premium is charged for the insurance coverage provided. This premium may be a percentage of the withdrawal base, a percentage of the covered asset pool and/or a percentage of the difference between the withdrawal base and the covered asset pool. A flat dollar amount could be included as an expense charge and discounts could be available for paying premiums in advance. The premium may apply only at the time the coverage is purchased (and whenever the withdrawal base is changed) or may be charged periodically. The premium may be deducted from the covered asset pool and/or paid with funds outside this pool.

The account owner may take withdrawals from the covered asset pool after the withdrawal guarantee has been purchased. However, withdrawals from the covered assets are typically restricted in some fashion, such as a maximum amount that the account owner can withdraw each year. The withdrawal restrictions may apply during a predetermined period of time (typically yearly) or may relate to multiple periods of time, e.g. designating the maximum withdrawal for a rolling three year period. The maximum withdrawal amount may be level or it may vary according to a formula such as a fixed percentage increase each year or it may be tied to an index, such as the Consumer Price Index. The maximum withdrawal amount could be higher in the early years to “bridge” income from working years to the time when Social Security or pension plan payments commence. To the extent the account owner takes withdrawals above the maximum withdrawal amount, an adjustment will be made to the withdrawal base, the withdrawal percentage, the premium charged, or to another aspect of the guarantee to compensate the insurance company for the potential increased risk caused by the excess withdrawal.

In some embodiments, the maximum withdrawal amount may be calculated by multiplying the withdrawal percentage by the withdrawal base. This percentage may be a single percentage or may vary by any of a number of factors, such as age, gender, number of lives covered, nursing, critical illness, or disability event, investment characteristics, duration since the withdrawal guarantee was purchased, or any other factor, such as the level of guarantee selected.

The account owner may start or stop the withdrawals or change the amount of the withdrawals (as long as the withdrawal amount is within the contractual maximum withdrawal amount). Alternatively, the account owner may set up a systematic withdrawal schedule with the administrator of the covered asset pool so that the administrator systematically provides the account owner with a predetermined withdrawal disbursement amount every month, year, or other period of time.

The insurable event (i.e., the depletion of a pool of covered assets) results in potential insurance guarantee payments to the owner of the account by the insurance company. In some embodiments, the loss indemnified is the amount of money the owner was entitled to receive prior to the depletion of the covered asset pool. This indemnification will continue for a predetermined period of time according to the contractual guarantee. In some embodiments, the contractual guarantee (and distribution, if any) continues for the lifetime of the account owner, such as with the GLWB products discussed in the Background section of this specification. In other embodiments, the contractual guarantee (and insurance guarantee payment, if any) is that the account owner will receive back a minimum amount of money (such as a return on their entire principal) through regular withdrawals such as with the GMWB product discussed in the Background section of this specification. In still other embodiments, the contractual guarantee (and insurance guarantee payment, if any) continues for a predetermined period of time, such as 10 years.

The form of the withdrawal guarantee is a contingent payout annuity. In general terms, a contingent payout annuity is an annuity that provides income payments upon the occurrence of a named contingency. In various embodiments there are a variety of contingencies that determine whether insurance guarantee payments are made from the insurance company to the account owner. One contingency is the depletion of the assets in the covered asset pool due to withdrawals, investment performance, charges, expenses, or a combination thereof. A second possible contingency is the survival of the owner of the account (or their joint owner). A third possible contingency is a nursing care, critical illness, or disability event, which may, for example, trigger the initiation or increase of annuity payments. Another possible contingency is death, where a death benefit is provided which ensures that upon the account owner's death, a minimum amount is available for the owner's heirs.

The amount of insurance guarantee payments, if any, is determined by reference to the account owner's deposit and withdrawal activity on the pool of covered assets and may be affected by the investment performance of the assets. The insurance guarantee payments, when made, may be level each year or may vary according to a formula such as a fixed percentage increase each year or may be tied to some index, such as the Consumer Price Index. The payments may be higher in the early years after retirement to “bridge” income from working years to the time when Social Security or pension plan payments commence. The payments may also be linked to the performance of an asset portfolio or financial market index, such as commonly reported stock indexes.

Although the account owner is generally free to choose the account his/her assets are held in, certain restrictions may be placed on the covered asset pool. These restrictions may take the form of a maximum percentage of the covered asset pool in a particular asset or asset class. For example, in certain embodiments the account owner cannot allocate more than 70% of the pool's assets into investments with equity exposure. To the extent assets fall outside these restrictions, assets will either be rebalanced to comply with the restrictions or an adjustment will be made to the withdrawal base, the withdrawal percentage, the premium charged, or to another aspect of the guarantee to compensate the insurance company for the additional risk assumed.

Periodically, details of the covered asset pool, such as deposit or withdrawal activity and/or asset holdings are reviewed. Whenever a deposit or withdrawal occurs, an adjustment to the withdrawal base may be made. If asset holdings are outside the agreed upon investment restrictions, transfers will be initiated to bring the covered asset pool back within its requirements or an adjustment will be made to the withdrawal base, the withdrawal percentage and/or the premium charged. If the withdrawal base is a function of the covered asset pool's performance, the withdrawal base may be adjusted periodically to reflect such performance. If the withdrawal base is a function of a mathematical formula or is tied to an index, it will be adjusted periodically.

In some embodiments, account information may be reported to the account owner periodically via regular mail, electronic mail, telephone, or any other suitable communication means. This account information may include covered asset pool values, withdrawal base, deposits, withdrawals, and/or policy beneficiaries.

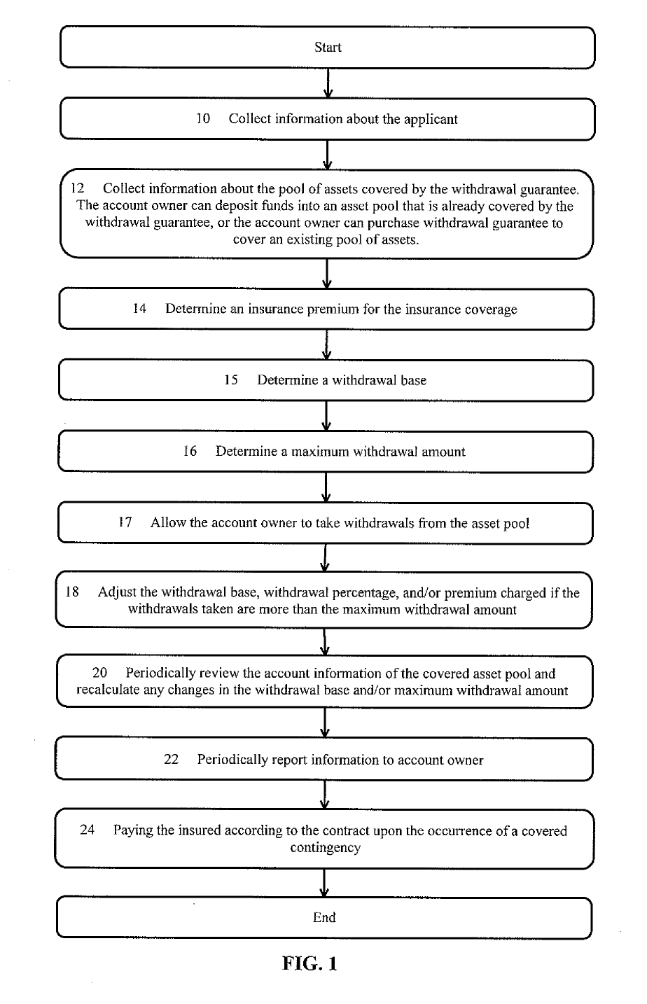

FIG. 1 is a flowchart of an embodiment of the invention. It should be noted that the steps shown in this flowchart do not have to be performed in the order they are shown. In this embodiment, the first step is for the insurance provider to obtain information from the applicant as seen in box 10. This information may include age, gender, social security number, address, assets the applicant desires to be covered by the insurance, and other information. In some embodiments, the information may be put into a computer system to help administer the withdrawal guarantee. The use of a computer to facilitate the administration of this invention is further described below.

The next step is to determine what pool of assets will be covered by the withdrawal guarantee as shown in box 12. The account owner can deposit funds into an asset pool that is already covered by the withdrawal guarantee, or the account owner can purchase the withdrawal guarantee to cover an existing pool of assets. In the embodiments where the assets are not held or controlled by the entity providing the guarantee, the entity providing the guarantee is in communication with the entity holding the assets to confirm the amount of the assets and the type of account in which assets are held. Once the information about the pool of covered assets is known, the insurance company can determine the insurance premium to be charged for the insurance coverage 14, the withdrawal base 15, and the maximum withdrawal amount 16.

The account owner is then allowed to take withdrawals 17 from the asset pool according to the contract. As shown in box 18, if the account owner takes withdrawals above the maximum withdrawal amount, an adjustment will be made to the withdrawal base, the withdrawal percentage, the premium charged, or to some other aspect of the guarantee to compensate the insurance company for the potential increased risk caused by the excess withdrawal.

As seen in boxes 20 and 22, information relating to the account and covered asset pool, such as deposit or withdrawal activity and/or asset holdings may be periodically reviewed and reported to the account owner.

According to the contract, there is at least one contingency that triggers the payment of insurance guarantee payments to the account owner. As seen in box 24, if the required contingency (or contingencies) is (are) met, then payments are made to the account owner according to the contract.

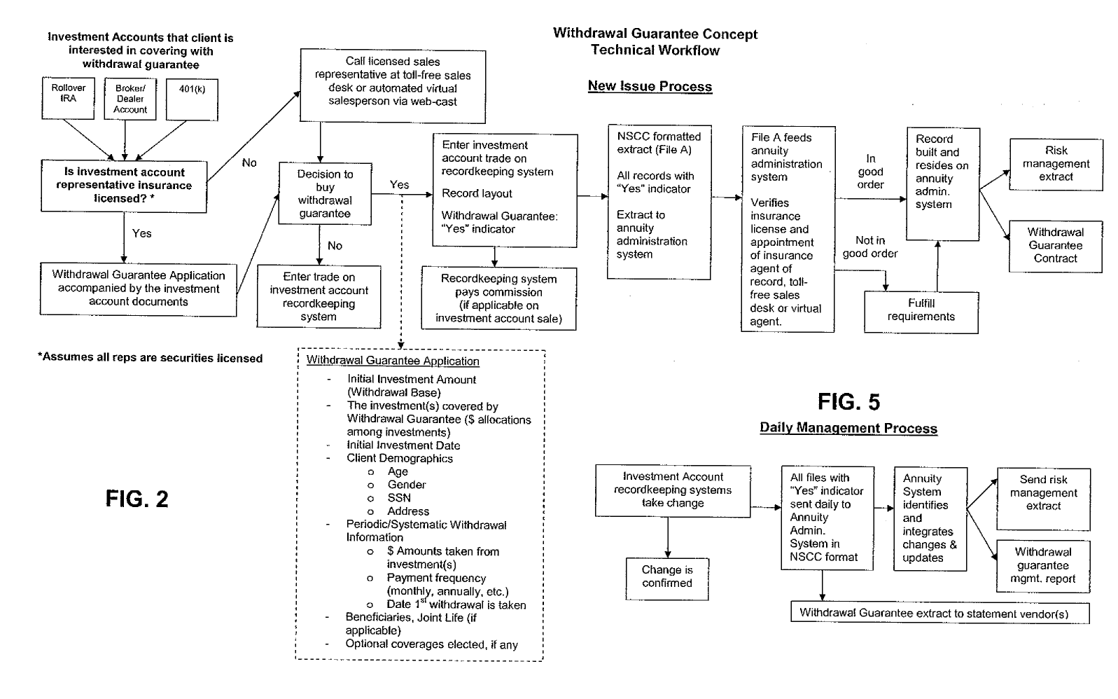

FIG. 2 shows an exemplary workflow flowchart for the present invention. FIG. 5 shows an exemplary flowchart of the daily management process of the present invention.

In some embodiments, a computer may be used to effectuate the management of the withdrawal guarantee. Data may be entered manually at a computer terminal or equivalent input device, or electronically, or in any other manner which is customary at present or in the future. For an existing contract, the data will generally be retrieved from an existing contract master record, or other file.

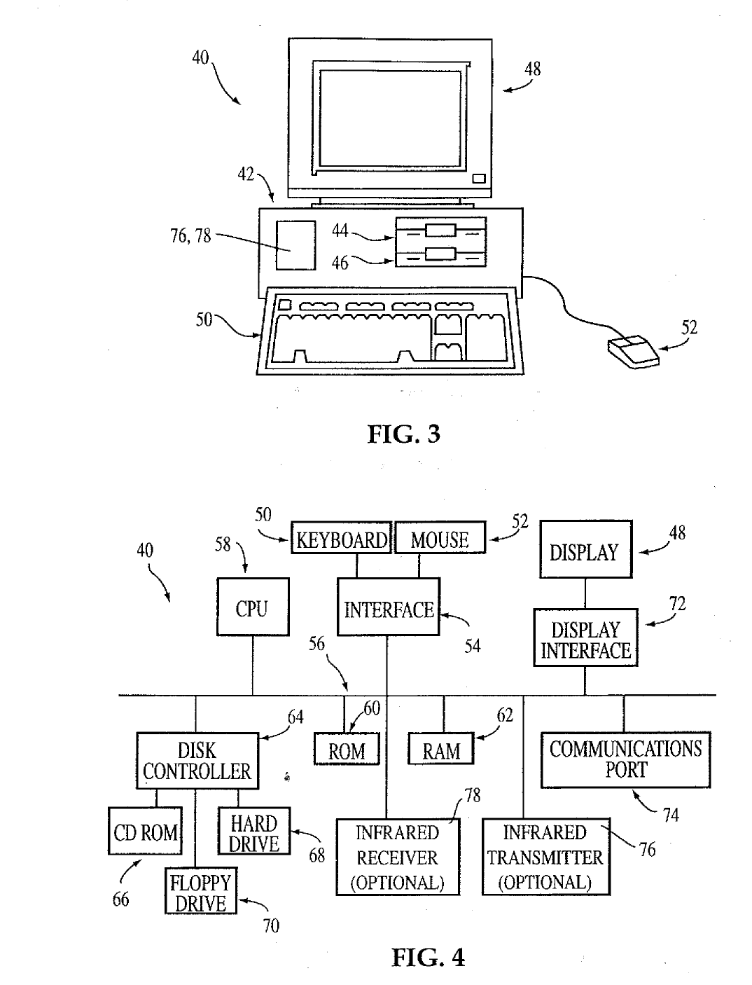

FIG. 3 is an illustration of a main central processing unit for implementing the computer processing in accordance with a computer implemented embodiment of the present invention. The procedures described above may be presented in terms of program procedures executed on, for example, a computer or network of computers.

Viewed externally in FIG. 3, a computer system designated by reference numeral 40 has a central processing unit 42 having disk drives 44 and 46. Disk drive indications 44 and 46 are merely symbolic of a number of disk drives which might be accommodated by the computer system. Typically these would include a floppy disk drive such as 44, a hard disk drive (not shown externally) and a CD ROM indicated by slot 46. The number and type of drives varies, typically with different computer configurations. Disk drives 44 and 46 are in fact optional, and for space considerations, may easily be omitted from the computer system used in conjunction with the production process/apparatus described herein.

The computer also has an optional display 48 upon which information is displayed. In some situations, a keyboard 50 and a mouse 52 may be provided as input devices to interface with the central processing unit 42. Then again, for enhanced portability, the keyboard 50 may be either a limited function keyboard or omitted in its entirety. In addition, mouse 52 may be a touch pad control device, or a track ball device, or even omitted in its entirety as well. In addition, the computer system also optionally includes at least one infrared transmitter 76 and/or infrared receiver 78 for either transmitting and/or receiving infrared signals, as described below.

FIG. 4 illustrates a block diagram of the internal hardware of the computer of FIG. 3. A bus 56 serves as the main information highway interconnecting the other components of the computer. CPU 58 is the central processing unit of the system, performing calculations and logic operations required to execute a program. Read only memory (ROM) 60 and random access memory (RAM) 62 constitute the main memory of the computer. Disk controller 64 interfaces one or more disk drives to the system bus 56. These disk drives may be floppy disk drives such as 70, or CD ROM or DVD (digital video disks) drive such as 66, or internal or external hard drives 68. As indicated previously, these various disk drives and disk controllers are optional devices.

A display interface 72 interfaces display 48 and permits information from the bus 56 to be displayed on the display 48. Again as indicated, display 48 is also an optional accessory. For example, display 48 could be substituted or omitted. Communication with external devices, for example, the components of the apparatus described herein, occurs utilizing communication port 74. For example, optical fibers and/or electrical cables and/or conductors and/or optical communication (e.g., infrared, and the like) and/or wireless communication (e.g., radio frequency (RF), and the like) can be used as the transport medium between the external devices and communication port 74.

In addition to the standard components of the computer, the computer also optionally includes at least one of infrared transmitter 76 or infrared receiver 78. Infrared transmitter 76 is utilized when the computer system is used in conjunction with one or more of the processing components/stations that transmits/receives data via infrared signal transmission.

The following are examples of the withdrawal guarantee of the present invention.

### EXAMPLE 1

An example of the invention is as follows. Assume a 57-year-old man planning for retirement (Account Owner) has $100,000 in his 401(k) account. He plans to retire at age 62. The assets in his 401(k) account include $80,000 in mutual funds on which the insurance company is willing to provide the withdrawal guarantee and $20,000 in other assets which will not be covered by the withdrawal guarantee. At the time of purchase of the withdrawal guarantee, the withdrawal base is set equal to the $80,000 of covered assets. A premium for the withdrawal guarantee is set at a predetermined level, such as 0.25% of the withdrawal base per quarter. The account owner has elected to pay this fee by debits from his cash management account which is part of a brokerage account outside of his 401(k) account. In the first quarter, the withdrawal guarantee premium is equal to 0.25% of the $80,000 withdrawal base, or $200. This is automatically debited from his cash management account and paid to the insurance company.

Assume the covered asset pool grows to $100,000 at the end of the first year and that the coverage provided steps up the withdrawal base to the account value each year. During the second year, the withdrawal base would be $100,000 and the quarterly fee would be 0.25% of this, or $250. Assume the covered asset pool drops to $75,000 by the end of the second year. The withdrawal base for the third year is still $100,000 and the quarterly fee is still $250. Assume the account value drops to $60,000 during the third year and the owner decides to retire and begin taking withdrawals from his 401(k) account. If the withdrawal guarantee allowed 5% withdrawals, he could withdraw 5% of his $100,000 withdrawal base, or $5,000, each year.

Assume after 8 years, his account value was depleted because of the $5,000 annual withdrawals and continued poor investment performance. At this point, the insurance company will begin making $5,000 per year insurance guarantee payments to him as a claim against his withdrawal guarantee policy. These payments would be made for as long as he lives.

### EXAMPLE 2

A second example of the invention follows. A husband and his wife retire at age 65 and begin taking the dividends from their mutual funds in cash to provide income. They roll their 401(k) account into an Individual Retirement Account funded with a variable deferred annuity and do not plan to tap these funds until they are required to do so at age 70½. They also own a vacation home.

After several years, they find that their expenses in retirement are higher than they had planned. They are considering increasing their withdrawals from their mutual funds but are concerned that by withdrawing their principal, they may eventually deplete their assets. They are also concerned about the effects a nursing care event could have on their assets. They decide to purchase a withdrawal guarantee to protect the retirement income being provided by the assets in their mutual fund account and in their annuity. The withdrawal base is set equal to their total mutual fund asset value of $200,000 plus their annuity asset value of $100,000. Their quarterly withdrawal guarantee premium is equal to 0.4% of their $300,000 withdrawal base, or $1,200. This is deducted from their mutual fund account each quarter. The withdrawals they are allowed to take from their covered assets are 6% of the withdrawal base, or $18,000 each year.

Two years later, they decide to sell their vacation home and deposit the $100,000 proceeds into a single premium variable life insurance contract. This policy was also acceptable as a covered asset so their withdrawal base was increased to $400,000. Because of this increase in withdrawal base, their premium increased to 0.4% of $400,000, or $1,600 each quarter and the amount of withdrawals they are able to take increased to 6% of $400,000, or $24,000 each year.

After several more years, the husband suffers a stroke and requires extended medical care in a nursing home. Their withdrawal guarantee provided optional coverage, which they elected, and now allows their withdrawals to be doubled to $48,000 per year. Because of a severe market downturn, their withdrawals depleted both their mutual fund and their variable annuity. After a couple more years they have now also depleted the funds from the variable universal life policy so all of their covered assets have been exhausted by their allowed withdrawals. At this point, the insurance company begins making $48,000 per year insurance guarantee payments under the withdrawal guarantee policy while the husband is still in the nursing home. After his death, the insurance company continues making $24,000 per year insurance guarantee payments to the surviving wife for the rest of her lifetime.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included with in the scope of the following claims.

What is claimed is as follows:

1. A method for providing a withdrawal guarantee on a pool of assets owned by an account owner, said method comprising the steps of:
obtaining information about the account owner;
determining the pool of assets that are to be covered by the withdrawal guarantee;
establishing an insurance premium for the insurance coverage;
calculating a withdrawal base;
calculating a maximum withdrawal amount; and
making insurance guarantee payments to the account owner upon the occurrence of one or more contingencies.

2. The method of claim 1 wherein the contingency is depletion of assets in the asset pool.

3. The method of claim 1 wherein the contingency is the survival of the owner of the account.

4. The method of claim 1 wherein the contingency is at least one of a nursing care, critical illness, or disability event.

5. The method of claim 4 wherein the nursing care, critical illness, or disability event allows for the amount of annuity payments to increase.

6. The method of claim 1 wherein the entity providing the withdrawal guarantee is different than the entity holding or controlling the covered assets.

7. The method of claim 1 wherein the entity providing the withdrawal guarantee is the same as the entity holding or controlling the covered assets.

8. The method of claim 1 wherein the contingency is death, where a death benefit is provided which ensures that upon the account owner's death, a minimum amount is available for the account owner's heirs.

9. The method of claim 1 wherein the pool of assets is a mutual fund account.

10. The method of claim 1 wherein the pool of assets is a 401(k) account.

11. The method of claim 1 wherein the pool of assets is an Individual Retirement Account (IRA).

12. The method of claim 1 wherein the pool of assets is a brokerage account.

13. The method of claim 1 wherein the withdrawal base is a function of the amount of funds deposited into or held in the covered asset pool.

14. The method of claim 1 wherein maximum withdrawal amount is a withdrawal percentage times the withdrawal base.

15. The method of claim 1 wherein the insurance premium is a percentage of the withdrawal base.

16. The method of claim 1 wherein the insurance premium is a percentage of the covered asset pool.

17. The method of claim 1 wherein the insurance premium is a percentage of the difference between the withdrawal base and the covered asset pool.

18. The method of claim 1 wherein a computer is used to effectuate the management of the withdrawal guarantee.

19. The method of claim 1 further comprising the step of periodically reviewing account information relating to the covered asset pool such as deposits, withdrawal activity, and asset holdings.

20. The method of claim 19 further comprising the step of periodically reporting account information to the account owner.

21. The method of claim 1 further comprising the step of increasing the withdrawal base when additional funds are added to the covered asset pool.

22. The method of claim 1 further comprising the step of increasing the withdrawal base up to the amount of the covered asset pool if such asset pool increased above the withdrawal base due to positive investment performance.

23. The method of claim 1 further comprising the step of decreasing the withdrawal base if the withdrawals taken are more than the maximum withdrawal amount.

24. The method of claim 1 further comprising the step of increasing the premium charged for the insurance coverage if the withdrawals taken are more than the maximum withdrawal amount.

25. The method of claim 1 wherein the insurance guarantee payments are made to the account owner for the life of the account owner.

26. A data processing method for administering a withdrawal guarantee on a pool of assets owned by an account owner, said method comprising the steps of:
storing data relating to the account owner on a computer;
determining the pool of assets that are to be covered by the withdrawal guarantee;
establishing an insurance premium for the insurance coverage;
using a computer to calculate a withdrawal base;
using a computer to calculate a maximum withdrawal amount; and
making insurance guarantee payments to the account owner in the form of a contingent payout annuity upon the occurrence of one or more contingencies.

27. A method for providing a withdrawal guarantee on a pool of assets owned by an account owner, said method comprising the steps of:
obtaining information from the account owner;
determining which pool of assets is to be covered by the withdrawal guarantee wherein the pool of assets is at least one of a mutual fund account, a 401(k) account, an Individual Retirement Account, a brokerage account, or a separately managed account;
wherein the entity providing the withdrawal guarantee is different than the entity holding or controlling the covered assets;
charging an insurance premium for the insurance coverage;
calculating a withdrawal base;
calculating a maximum withdrawal amount; and
making insurance guarantee payments to the account owner upon the occurrence of one or more contingencies.

28. A method for providing a withdrawal guarantee on a pool of assets owned by an account owner, said method comprising the steps of:
obtaining information about the account owner;
determining the pool of assets that are to be covered by the withdrawal;
establishing an insurance premium for the insurance coverage;
calculating a withdrawal base;
calculating a maximum withdrawal amount; and
making insurance guarantee payments to the account owner upon the occurrence of one or more contingencies;
wherein the entity providing the withdrawal guarantee is different than the entity holding or controlling the covered assets.
